(19) United States
(12) Patent Application Publication
(10) Pub. No.: US 2005/0131962 A1
(43) Pub. Date: Jun. 16, 2005

(54) Systems and methods for implementing a cache model

(76) Inventor: Sachin G. Deshpande, Vancouver, WA (US)

Correspondence Address: MADSON & METCALF, 15 WEST SOUTH TEMPLE, SUITE 900, SALT LAKE CITY, UT, 84101, US

(21) Appl. No.: 10/737,543

(22) Filed: Dec. 16, 2003

(51) Int. Cl. G06F 17/30

(52) U.S. Cl. 707/201

(57) ABSTRACT

Systems and methods for implementing a cache model are disclosed. An exemplary embodiment includes a cache manager for implementing a method in a client. The client includes a cache that includes a portion of an image file received from a server. The entire image file is stored on the server. The method implemented by the cache manager involves creating a cache model. The cache model includes a representation of contents of the cache. The method also involves saving the cache model on the client. The method also involves updating the cache model to reflect modifications made to the contents of the cache. The cache model may also be created and stored similarly on the server to model the client's cache.

### TECHNICAL FIELD

The present invention relates generally to digital images. More specifically, the present invention relates to systems and methods for the efficient transfer of and cache modeling for digital image files from a server to a client.

### BACKGROUND

Digital images are often described as bitmaps formed of individual pixels. Digital images may result from either real world capture or computer generation. A scanner and/or a digital camera may be used to capture digital images. Computer generation can be performed with the use of a paint program, screen capture, the conversion of a graphic into a bitmap image, etc.

In the simplest type of digital image, each pixel has only one of two values: black or white. For such a digital image, pixel encoding requires only one bit. If shades of gray are present within a digital image, two values are no longer sufficient for pixel encoding. Instead, each pixel is typically assigned a numerical value which is proportional to the brightness of that point. Such a digital image is often referred to as a grayscale image.

The encoding of color digital images takes advantage of the fact that any color can be expressed as a combination of three primary colors, such as red, green, and blue (RGB) or yellow, magenta, and cyan (YMC). Therefore, a color digital image can be thought of as the superposition of three color component planes. Within each plane, the brightness of a primary color is encoded. Some digital images, such as multi-spectral images, may have more than three planes of information.

Uncompressed digital images require considerable storage space, significant transmission bandwidth, and lengthy transmission time. Thus, digital images are typically compressed before their storage and transmission. Then, at the receiver end, the compressed images can be decompressed.

Some types of compressed digital images may be decompressed in different ways to display different images with different properties. For example, some digital images may be decompressed to any image quality, up to and including a maximum level of quality chosen at compression time. As another example, some digital images may be decompressed to any size, up to and including a maximum size chosen at compression time. As yet another example, some digital images are compressed in such a way that it is possible to decompress only a certain region of the digital image, or a specific component of the image (e.g., the grayscale component of a color image or overlay components containing text or graphics). The JPEG2000 standard describes compressed digital images that are configured in this manner.

There are many applications for compressed images having the above characteristics. For example, it may be desirable to decompress an image to a high resolution and a high level of quality for display on a desktop computer. However, it may be desirable to decompress the same image to a lower resolution and/or a lower level of quality for display on a handheld computing device, such as a cellular telephone, PDA, etc.

In view of the foregoing, benefits may be realized by improvements relating to the way that a client manages digital image files, and portions thereof, that have been received from a server.

### BRIEF DESCRIPTION OF THE DRAWINGS

The present embodiments will become more fully apparent from the following description and appended claims, taken in conjunction with the accompanying drawings. Understanding that these drawings depict only typical embodiments and are, therefore, not to be considered limiting of the invention's scope, the embodiments will be described with additional specificity and detail through use of the accompanying drawings in which:

FIG. 1 is a block diagram illustrating an exemplary system in which some embodiments may be practiced;

FIG. 2 is a block diagram illustrating an embodiment of the cache model;

FIG. 3 is flow diagram illustrating an exemplary method that may be performed by the cache manager in the system of FIG. 1;

FIG. 4 is a signal flow diagram for the different components in the system of FIG. 1 while the method of FIG. 3 is being performed;

FIG. 5 is flow diagram illustrating another exemplary method that may be performed by the cache manager;

FIG. 6 is a block diagram illustrating another embodiment of the cache model;

FIG. 7 is a block diagram illustrating the components typically utilized in a client or a server used with embodiments herein;

FIG. 8 is a block diagram illustrating another embodiment of a system in which some embodiments may be practiced;

FIG. 9 is a diagram showing the structure of a document using XML based cache modeling;

FIG. 10 is a diagram showing a client side cache model view when a session between a JPIP client and a JPIP server is started;

FIG. 11 is a diagram showing the client side cache model view while the JPIP client and the JPIP server are in a session; and

FIG. 12 is a diagram showing the client side cache model view in tree form after a purge operation is performed at the client.

### DETAILED DESCRIPTION

A cache manager for implementing a method in a client is disclosed. The client includes a cache that includes a portion of an image file received from a server. The method may involve creating a cache model that includes a representation of contents of the cache. In some embodiments, creating the cache model may involve loading a previously saved cache model. The method may additionally involve saving the cache model on the client, and updating the cache model to reflect modifications made to the contents of the cache.

The image file may include compressed image data. The compressed image data may be configured to be decompressed in different ways to display different images with different properties. In some embodiments, the image file is formatted in accordance with JPEG2000.

The cache model may include an identifier of the portion of the image file, and at least one characteristic of an image that is displayed from the portion of the image file. In some embodiments, the cache model may additionally include a tile data structure, a component data structure, a resolution data structure, a precinct data structure, and a layer data structure. The tile data structure, component data structure, resolution data structure, precinct data structure, and layer data structure may be related to each other in accordance with a hierarchy that corresponds to a progression order of the image file. The identifier may be embedded within the lowest data structure in the hierarchy. The at least one characteristic may include a tile that is specified in a tile attribute of the tile data structure, a component that is specified in a component attribute of the component data structure, a resolution that is specified in a resolution attribute of the resolution data structure, a precinct that is specified in a precinct attribute of the precinct data structure, and a layer that is specified in a layer attribute of the layer data structure. The cache model may include XML data and may be embodied as an XML file.

The method may also involve modifying the cache. The method may also involve sending update information to the server. The update information may describe the modifications made to the contents of the cache. The method may also involve associating saved cache model information with the image file and with the server, and reading the saved cache model information based on the image file and the server.

In some embodiments, the updating of the cache model may be accomplished via a document object model. Alternatively, the updating of the cache model may be accomplished via an XML document object model application programming interface.

A cache manager for implementing a method in a server is also disclosed. The server models contents of a cache on a client. The cache includes a portion of an image file received by the client from the server. The method may involve creating a cache model that includes a representation of the contents of the cache on the client. Creating the cache model may involve loading a previously saved cache model. The method may also involve saving the cache model on the server, and updating the cache model to reflect modifications made to the contents of the cache on the client based on information sent by the client to the server.

A client that is in electronic communication with a server is also disclosed. The client includes a cache that stores a portion of a compressed image file received from the server. The compressed image file may be configured to be decompressed in different ways to display different images with different properties. The client also includes a cache model that includes a representation of contents of the cache. The client also includes a cache manager that updates the cache model to reflect modifications made to the contents of the cache.

A server that is in electronic communication with a client is also disclosed. The server includes a cache model that includes a representation of contents of a cache on the client. The cache stores a portion of a compressed image file received by the client from the server. The compressed image file is configured to be decompressed in different ways to display different images with different properties. The server also includes a cache manager that updates the cache model to reflect modifications made to the contents of the cache based on information sent by the client to the server.

A method is disclosed for implementation in a client that includes a cache that stores a portion of a compressed image file received from a server. The method may involve creating a cache model. The cache model includes a representation of contents of the cache. The method may additionally involve saving the cache model on the client, and updating the cache model to reflect modifications made to the contents of the cache.

A method is also disclosed for implementation in a server. The method may involve creating a cache model. The cache model includes a representation of contents of a cache on a client. The method may also involve saving the cache model on the server, and updating the cache model to reflect modifications made to the contents of the cache based on information sent by the client to the server.

A cache manager is also disclosed for implementing a method in a client that is configured for communication with a server in accordance with JPEG2000 Interactive Protocol (JPIP). The client includes a cache. The cache includes a portion of a JPEG2000 image file received from the server. The method involves saving cache information about contents of the cache into an XML file in accordance with an XML DTD/schema. The method also involves reading the XML file. The method also involves using XML Document Object Model (DOM) Application Programming Interface (API) to create a hierarchical representation of the cache information. When first data is added to the cache, the method also involves using the XML DOM API to add a first node to the hierarchical representation. When second data is removed from the cache, the method also involves using the XML DOM API to delete a second node from the hierarchical representation. In some embodiments, when the first data is added to the cache, the method additionally involves sending a Cache-Model: add=<data-bin descriptors> header to the server. When the second data is removed from the cache, the method may also involve sending a Cache-Model: subtract=<data-bin descriptors> header to the server.

The XML DTD/schema may define a tile element, a component element, a resolution element, a precinct element, and a layer element. The tile element, the component element, the resolution element, the precinct element, and the layer element may each have required attributes of start and end. The tile element, the component element, the resolution element, the precinct element, and the layer element may each have an implied attribute of identifier. The XML DTD/schema may define a progression order for the tile element, the component element, the resolution element, the precinct element, and the layer element.

Various embodiments of the invention are now described with reference to the Figures, where like reference numbers indicate identical or functionally similar elements. It will be readily understood that the components of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Those skilled in the art will appreciate that many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, those skilled in the art will recognize that such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

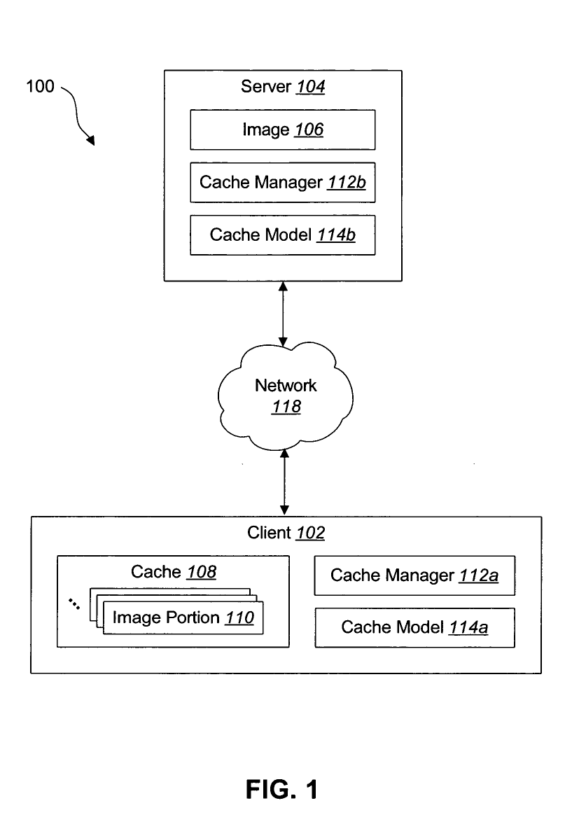

FIG. 1 is a block diagram illustrating an exemplary system 100 in which some embodiments may be practiced. As shown, embodiments disclosed herein may involve interaction between a client 102 and a server 104.

A file containing a compressed image 106 is stored on the server 104. In typical embodiments, the compressed image 106 may be decompressed in different ways to display different images with different properties, as discussed above. The client 102 includes a cache 108 for storing image data received from the server 104. In typical embodiments, it is possible to locate, extract, and decode only the image data that is required for the desired image product. In other words, if a smaller or lower quality image is desired, it is generally not necessary to decode all of the image data in the compressed image 106.

Because all of the image data in the image 106 is not always needed, when the client 102 requests a compressed image 106 from the server 104, the server 104 may not send all of the image data in the compressed image 106 to the client 102. Instead, the server 104 may only send a portion of the file containing the compressed image 106 to the client 102, namely, the portion that is needed in order to generate the image having the desired characteristics. Only sending the needed portion of the image file 106 generally improves the communication efficiency between the client 102 and the server 104. Accordingly, in some situations the client cache 108 may only include a portion 110 of an image file 106 that is stored on the server 104.

The client 102 also includes a cache manager 112a. The cache manager 112a retrieves image data from the server 104 and stores it in the cache 108. In some embodiments, a different client-side component may retrieve image data from the server 104 and communicate the retrieved data or information about the retrieved data to the cache manager 112a. The cache manager 112a also creates and maintains a cache model 114a, which includes a representation of the current contents of the cache 108. The cache model 114a is used by the client 102 to determine the image file portions 110 that are stored in the cache 108, so that the client 102 does not request an image file portion 110 from the server 104 when that image file portion 110 is already stored in the cache 108. Whenever a modification is made to the cache 108 (e.g., image data is added to or deleted from the cache 108), the cache manager 112a updates the cache model 114a to reflect the modified contents of the cache 108. Additional details about various embodiments of the cache manager 112a and the cache model 114a will be described below.

The server 104 may also include a cache manager 112b. The cache manager 112b on the server 104 also creates and maintains a cache model 114b, which also includes a representation of the current contents of the client's cache 108. The cache model 114b is used by the server 104 to determine the image file portions 110 that are stored in the client's cache 108, so that the server 104 does not send an image file portion 110 to the client 102 when that image file portion 110 is already stored in the client's cache 108. Whenever a modification is made to the client's cache 108, the cache manager 112b updates the cache model 114b on the server 104 to reflect the modified contents of the client's cache 108. Additional details about various embodiments of the cache manager 112b and the cache model 114b on the server 104 will be described below.

The JPEG2000 standard defines a cache model. The cache model can be employed by the server 104 to model the contents of the client's cache 108. However, the JPEG2000 standard does not define how the client 102 and the server 104 keep track of the cache model of the client's cache.

The client 102 and the server 104 may be in electronic communication with each other over one or more computer networks 118. Thus, data transmitted from the client 102 to the server 104, and vice versa, may pass through one or more intermediate nodes en route to its destination. Embodiments may be used in local area networks (LANs), storage area networks (SANs), metropolitan area networks (MANs), wide area networks (WANs), and combinations thereof (e.g., the Internet) with no requirement that the client 102 and the server 104 reside in the same physical location, the same network 118 segment, or even in the same network 118. A variety of different network configurations and protocols may be used, including Ethernet, TCP/IP, UDP/IP, EEE 802.11, IEEE 802.16, Bluetooth, asynchronous transfer mode (ATM), fiber distributed data interface (FDDI), token ring, and so forth, including combinations thereof. Of course, some embodiments may also be practiced with conventional point-to-point connections, such as enterprise systems connection (ESCON), small computer system interface (SCSI), fibre channel, etc., that may not typically be viewed as a “network.”

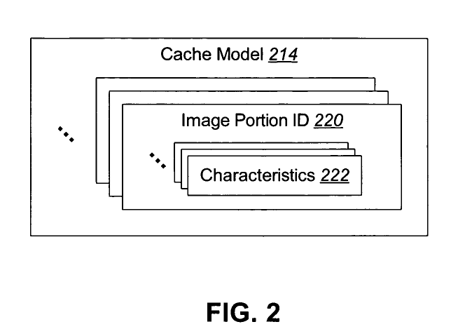

FIG. 2 is a block diagram illustrating an embodiment of the cache model 214. The cache model 214 shown in FIG. 2 may be stored on the client 102 and/or on the server 104. The cache model 214 includes a different identifier 220 for each image file portion 110 that is stored in the cache 108. The identifier 220 may be embodied as a reference to the image file portion 110, such as a file path. Alternatively, the identifier 220 may be embodied as the image file portion 110 itself.

Within the cache model 214, each identifier 220 of an image file portion 110 is associated with one or more characteristics 222 of the image that may be displayed by decompressing the image file portion 110. Examples of different characteristics 222 include quality, size, region, component, etc., as discussed above. The identifier 220 for a particular image file portion 110 and the associated characteristics 222 may be included in the same data structure within the cache model 214. In some implementations, the cache model 214 may be embodied as an XML file. The cache model 214 is associated with the particular image which is obtained by the client 102 from the server 104.

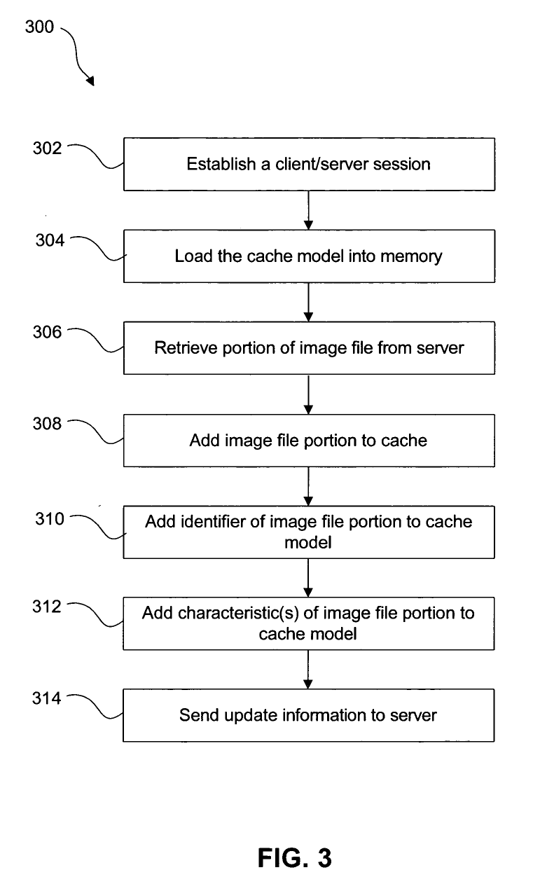

FIG. 3 is a flow diagram illustrating an exemplary method 300 that may be performed by the cache manager 112a on the client 102. The method 300 begins when a session between the client 102 and the server 104 is established 302 and the cache model 114 is loaded 304 into memory. Where the cache model 114 is an XML file, loading the cache model 114 into memory is typically accomplished by means of an XML document object model, which builds a tree-like representation of the XML file in the memory. In some embodiments, the cache model 114 that is loaded 304 is from a previous session between the client 102 and the server 104 for the same image resource. In alternative embodiments, where there has not been a previous session between the client 102 and the server 104 for the particular image, there may be no previous cache model 114 information on the client 102 side. In this situation, a new cache model 114 may be created instead of loading a previous cache model 114.

The contents of the cache 108 are then modified. More specifically, image data corresponding to a portion 110 of a compressed image file 106 is retrieved 306 from the server 104. An image file portion 110 may be retrieved 306 from the server 104 in many different ways. In some embodiments, the client 102 may request an image 106 from the server 104 and specify the desired image characteristics (e.g., size, quality, etc.) in the request. The server 104 then determines the portion 110 of the image file 106 that is needed in order to produce an image with the requested characteristics, and sends that portion of the image file 106 to the client 102. Alternatively, the client 102 may determine the portion 110 of the image file 106 that is needed for the desired image characteristics, and may request only that portion 110 of the image file 106 from the server 104. Alternatively still, the client 102 may request an image file 106 from the server 104 without specifying the image characteristics. The server 104 may then determine the image characteristics based on, for example, the server's 104 knowledge of the client's 102 capabilities and/or the properties of the transmission medium between the server 104 and the client 102. The server 104 then determines the portion 110 of the image file 106 that is needed to generate an image with those characteristics, and sends that portion 110 of the image file 106 to the client 102. Of course, other ways in which a portion 110 of an image file 106 may be retrieved from the server 104 are known to those skilled in the art.

The client-side cache manager 112a then updates the client-side cache model 114a to reflect the modifications that have been made to the cache 108. More specifically, the portion 110 of the image file 106 that is retrieved from the server 104 is added 308 to the cache 108. An identifier 220 for the retrieved image file portion 110 is added 310 to the cache model 114. The characteristics 222 of the image that may be displayed by decompressing the retrieved image file portion 110 are added 312 to some or all of the cache model 114 and associated with the identifier 220.

As described above, in some embodiments the server 104 may also include a model 114b of the client's cache 108. It may be desirable for the cache model 114b on the server 104 to be synchronized with the cache model 114a on the client 102. In such embodiments, the method 300 may additionally involve the client-side cache manager 112a sending 314 update information to the server-side cache manager 112b. The update information typically includes information about the image file portions 110 that have been added to and/or deleted from the client-side cache model 114a. The server-side cache manager 112b may then modify the server-side cache model 114b in accordance with the update information. More specifically, the server-side cache manager 112b may load the server-side cache model 114b into memory and update the server-side cache model 114b to reflect the modifications that have been made to the cache 108 on the client 102. The server-side cache manager 112b may update the server-side cache model 114b in a similar manner to the way that the client-side cache manager 112a updates the client-side cache model 114a, as described above with respect to steps 310 and 312 of the method 300.

In some embodiments, the cache model 114 may be embodied as an XML file. In such embodiments, the cache manager 112 may utilize a document object model (DOM) and/or DOM application programming interface (API) to modify the cache model 114. Document object models are known to those skilled in the art.

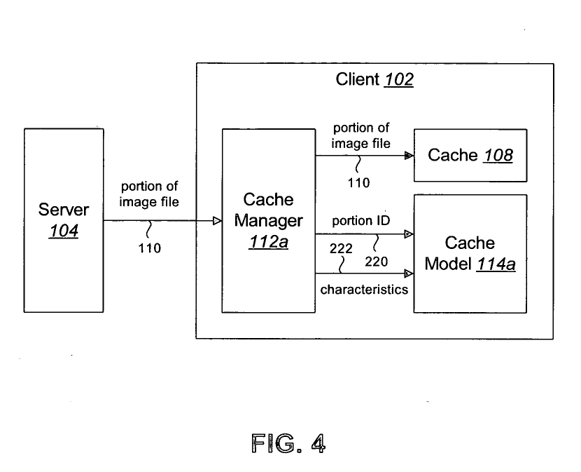

FIG. 4 is a signal flow diagram for the different components in the system 100 of FIG. 1 while the method 300 of FIG. 3 is being performed. As shown, the server 104 sends a portion 110 of the image file 106 to the client-side cache manager 112a. The cache manager 112a adds the portion 110 of the image file 106 that is retrieved from the server 104 to the cache 108. The cache manager 112a adds an identifier 220 for the retrieved image file portion 110 to the client-side cache model 114a. The cache manager 112a associates the identifier 220 with the characteristics 222 of the image that may be displayed by decompressing the corresponding image file portion 110.

As described above, the client 102 may determine the desired image characteristics 222 (e.g., size, quality, etc.) prior to making a request to the server for the image file 106. In such embodiments, the characteristics 222 to be associated with the identifier 220 are already known by the client 102. Alternatively, as also discussed above, the server 104 may determine the image characteristics 222 in response to a request for an image file 106 from the client 102. In such embodiments, the cache manager 112a may determine the characteristics 222 to be associated with the identifier 220 by examining the image file portion 110 received from the server 104. The characteristics 222 may be, for example, included in a header of the image file portion 110.

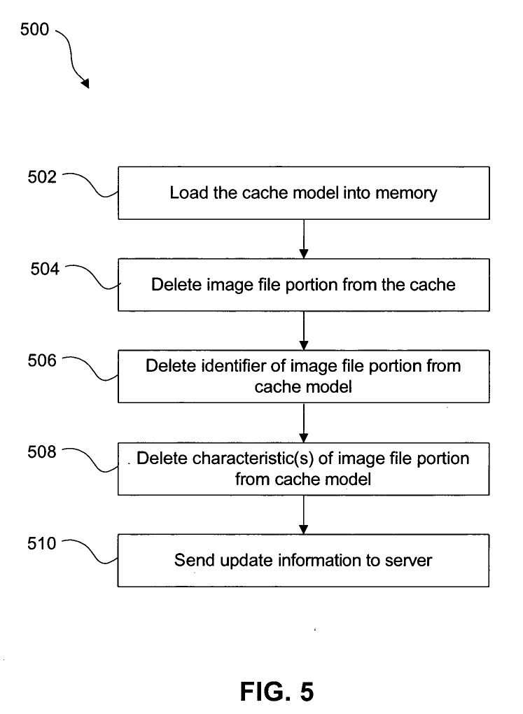

FIG. 5 is flow diagram illustrating another exemplary method 500 that may be performed by the cache manager 112a on the client 102. The method 500 begins when the cache model 114a is loaded 502 into memory. In some embodiments, the cache model 114a that is loaded 304 is from a previous session between the client 102 and the server 104 for the same image resource. In alternative embodiments, where there has not been a previous session between the client 102 and the server 104 for the particular image, there may be no previous cache model 114a information on the client 102 side. In this situation, a new cache model 114a may be created instead of loading a previous cache model 114a.

The contents of the cache 108 are then modified. More specifically, the client-side cache manager 112a deletes 504 an image file portion 110 from the client's cache 108. This may be done because the cache 108 is getting too full, the image file portion 110 hasn't been used in a long time, etc.

The cache manager 112a then updates the client-side cache model 114a to reflect the modifications that have been made to the cache 108. More specifically, the cache manager 112a deletes 506 the identifier 220 of the image file portion 110 from the client-side cache model 114a. The characteristics 222 associated with the identifier 220 are also deleted 508 from the cache model 114a.

As described above, in some embodiments the server 104 may also include a model 114b of the client's cache 108. It may be desirable for the cache model 114b on the server 104 to be synchronized with the cache model 114a on the client 102. In such embodiments, the method 500 may involve the client-side cache manager 112a sending 510 update information to the server 104. The update information typically includes information about the image file portion 110 that was deleted from the client-side cache model 114a. The server-side cache manager 112b may then delete the image file portion 110 (and associated image characteristics) from the server-side cache model 114b.

Within JPEG2000, a “tile” is a rectangular array of points within an image. A “component” is a two-dimensional array of samples. A color image typically consists of several components from a specified color space, such as red, green, and blue. “Resolution” refers to the spatial mapping of samples to a physical space. A “precinct” is a subdivision of a tile-component. A “layer” is a collection of coding pass compressed data from one, or more, code-blocks of a tile-component.

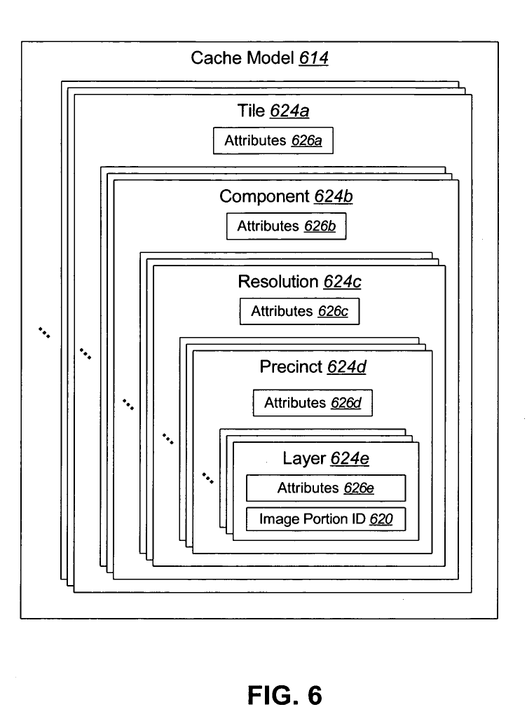

FIG. 6 is a block diagram illustrating another embodiment of the cache model 614. In the illustrated embodiment, the cache model 614 includes a plurality of data structures 624. More specifically, the cache model 614 includes one or more tile data structures 624a, one or more component data structures 624b, one or more resolution data structures 624c, one or more precinct data structures 624d, and one or more layer data structures 624e.

Each data structure 624 includes one or more attributes 626. The attributes 626a of a tile data structure 624a identify one or more tiles of the image 106. The attributes 626b of a component data structure 624b identify one or more components of the image 106. The attributes 626c of a resolution data structure 624c identify one or more resolutions of the image 106. The attributes 626d of a precinct data structure 624d identify one or more precincts of the image 106. The attributes 626e of a layer data structure 624e identify one or more layers of the image 106.

The data structures 624 in the cache model 614 are organized in accordance with a hierarchy. More specifically, each component data structure 624b is a child of a tile data structure 624a. Each resolution data structure 624c is a child of a component data structure 624b. Each precinct data structure 624d is a child of a resolution data structure 624c. Each layer data structure 624e is a child of a precinct data structure 624d.

The hierarchy of the data structures 624 in the cache model 114 corresponds to a possible progression order of the packets in an image file 106. In JPEG2000, a “progression order” refers to the order in which packets in the image may be interleaved. The progression order corresponding to the illustrated cache model 614 is tile-component-resolution-precinct-layer. However, many different kinds of progression orders are known to those skilled in the art. The JPEG2000 standard defines five different progression orders, and others may be defined. Different data structure hierarchies corresponding to different progression orders may be utilized in alternative embodiments.

As described previously in connection with FIG. 2, the cache model 614 typically includes a different identifier 620 for each image file portion 110 in the cache 108. In the illustrated cache model 614, the identifiers 620 of image file portions 110 are included in the data structure 624 that is lowest in the hierarchy (e.g., the layer data structure 624e in FIG. 6).

Also as described previously, each identifier 620 of an image file portion 110 may be associated with one or more characteristics of the image that may be displayed by decompressing the image file portion 110. In the illustrated cache model 614, the characteristics associated with a particular image file portion 110 are the attributes 626 of the data structures 624 in which the corresponding identifier 620 is located.

In some implementations, the cache model 614 may be embodied as an XML file, and the different data structures 624 may be embodied as XML elements. For example, each tile data structure 624a in the illustrated cache model 614 may be embodied as a tile element that is a root element of the XML file. Each component data structure 624b may be embodied as a component element that is a child element of a tile element. Each resolution data structure 624c may be embodied as a resolution element that is a child element of a component element. Each precinct data structure 624d may be embodied as a precinct element that is a child element of a resolution element. Each layer data structure 624e may be embodied as a layer element that is a child element of a precinct element.

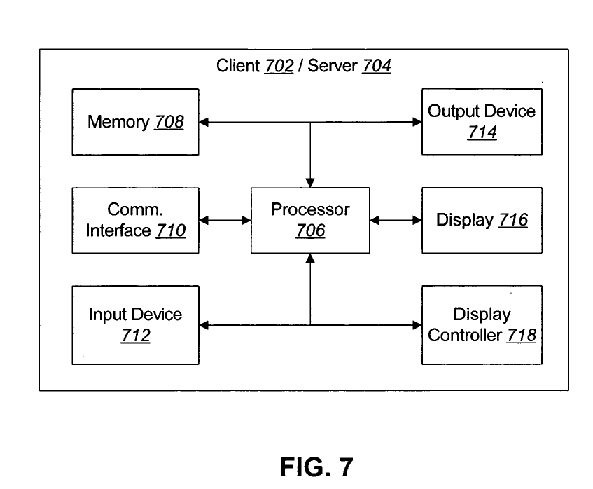

FIG. 7 is a block diagram illustrating the components typically utilized in a client 702 or a server 704 used with embodiments herein. The illustrated components may be logical or physical and may be implemented using any suitable combination of hardware, software, and/or firmware. In addition, the different components may be located within the same physical structure or in separate housings or structures.

The server 704 includes a processor 706 and memory 708. The processor 706 controls the operation of the computer system and may be embodied as a microprocessor, a microcontroller, a digital signal processor (DSP) or other device known in the art. The processor 706 typically performs logical and arithmetic operations based on program instructions stored within the memory 708.

As used herein, the term “memory” 708 is broadly defined as any electronic component capable of storing electronic information, and may be embodied as read only memory (ROM), random access memory (RAM), magnetic disk storage media, optical storage media, flash memory devices in RAM, on-board memory included with the processor 706, EPROM memory, EEPROM memory, registers, etc. The memory 708 typically stores program instructions and other types of data. The program instructions may be executed by the processor 706 to implement some or all of the methods disclosed herein.

The server 704 typically also includes one or more communication interfaces 710 for communicating with other electronic devices. The communication interfaces 710 may be based on wired communication technology, wireless communication technology, or both. Examples of different types of communication interfaces 710 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The server 704 typically also includes one or more input devices 712 and one or more output devices 714. Examples of different kinds of input devices 712 include a keyboard, mouse, microphone, remote control device, button, joystick, trackball, touchpad, lightpen, etc. Examples of different kinds of output devices 714 include a speaker, printer, etc. One specific type of output device which is typically included in a computer system is a display device 716. Display devices 716 used with embodiments disclosed herein may utilize any suitable image projection technology, such as a cathode ray tube (CRT), liquid crystal display (LCD), light-emitting diode (LED), gas plasma, electroluminescence, or the like. A display controller 718 may also be provided, for converting data stored in the memory 708 into text, graphics, and/or moving images (as appropriate) shown on the display device 716.

Of course, FIG. 7 illustrates only one possible configuration of a server 704. Those skilled in the art will recognize that various other architectures and components may be utilized. In addition, various standard components are not illustrated in order to avoid obscuring aspects of the invention.

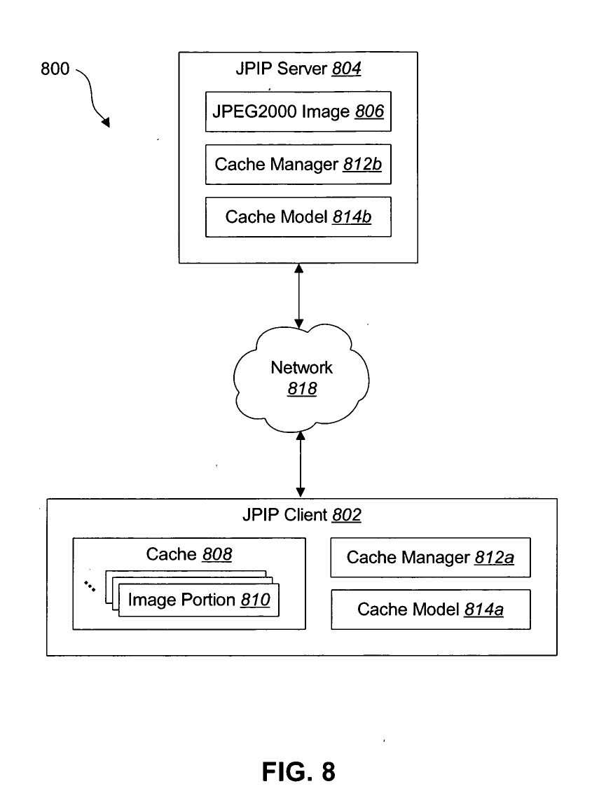

FIG. 8 is a block diagram illustrating another embodiment of a system 800 in which some embodiments may be practiced. The system 800 includes a client 802 and a server 804 that are configured to communicate in accordance with the JPEG 2000 Interactive Protocol (“JPIP”). JPIP is currently being finalized by ISO/IEC JTC 1/SC 29/WG 1. JPIP specifies a protocol consisting of a structured series of interactions between a client 802 and a server 804 by means of which image file metadata, structure and partial or whole image codestreams may be exchanged in a communications efficient manner.

The JPIP client 802 includes a cache model 814a. When a session between the JPIP client 802 and the JPIP server 804 is started, the client 802 will read its stored information from a previous session with the JPIP server 804 (if it exists) using XML Document Object Model (DOM). Thus using DOM API, the parser will build a tree like representation in the memory. After this any Cache-Model: add=<data-bin descriptors> and Cache-Model: subtract=<data-bin descriptor> headers will be sent to the server 804 as adding and purging of cache happens at the client 802. At the same time the DOM API for adding and removing nodes will be used to update the client side cache model 814a.

In some circumstances, it may be advantageous to use XML for JPIP client side cache modeling because XML is a standardized and easily exchangeable approach. Also, the JPIP cache model descriptors follow a hierarchical structure, which can be very well represented using XML. In addition, using the DOM API helps with adding, deleting, and otherwise updating the cache model 814a. After a stateful session is finished the DOM API can be used to easily and conveniently store the current cache state at the client side 802. This stored information can be easily retrieved to build the client side cache structure when the next session of interaction between the server 804 and the client 802 occurs.

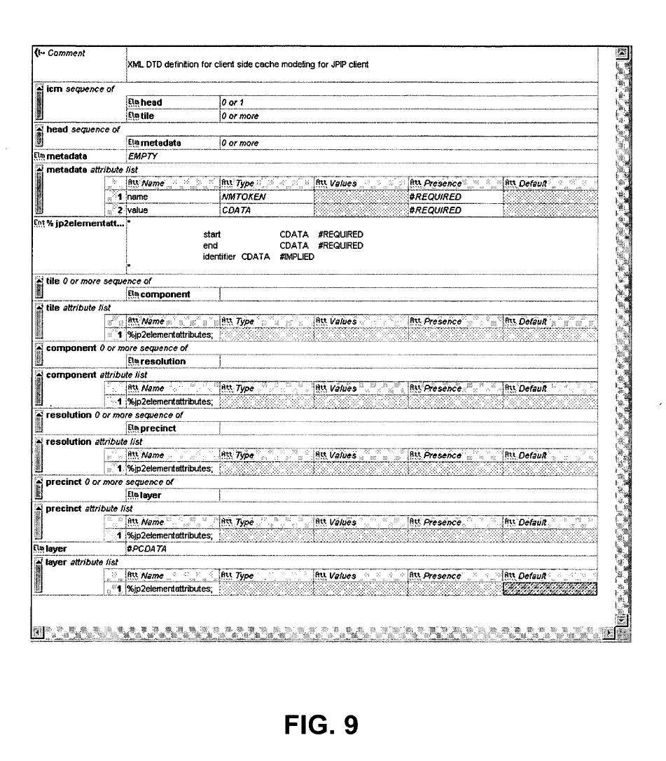

An example of an XML DTD for XML based JPIP client side cache modeling will now be described. Each icm XML document in this exemplary XML DTD consists of a sequence of zero or one head element and zero or more tile elements. The head element consists of zero or more metadata elements which have a name and a value pair as its attributes. The tile element consists of a sequence of zero or more component elements. The component element consists of a sequence of zero or more resolution elements. The resolution element consists of a sequence of zero or more precinct elements. The precinct element consists of a sequence of zero or more layer elements. Each of the tile, component, resolution, precinct and layer element have required attributes of start and end which represent their index (tile-index/component-index/resolution-index/precinct-index/layer number) and an implied attribute of identifier. The layer element can contain parsed character data. This may be, for example, a file on the client side holding the actual cache data. It is also possible to embed the actual cache data here. This is an implementation choice and this exemplary DTD provides flexibility to use any of these approaches as suitable. FIG. 9 shows a detailed diagram showing the structure of a document using this exemplary XML based cache modeling.

An XML DTD for client side cache modeling is defined below. It can be used for implicit form cache descriptors. Alternate embodiments are possible. These include using a different permutation for tile, component, resolution, precinct and layer hierarchy. In fact JPEG2000 standard document defines 5 different orderings. For a given tile, the order in which the packets are interleaved is called the progression order. The interleaving of the packets can progress along four axes: layer, component, resolution and precinct. There are five allowable progression orders in the standard which are signaled by the COD and/or Progressive order change default (POD) markers in the main header.
1. Layer-resolution-component-position progressive,
2. Resolution-layer-component-position progressive,
3. Resolution-position-component-layer progressive,
4. Position-component-resolution-layer progressive,
5. Component-position-resolution-layer progressive.

Any of these progression orders can be used to define a XML DTD similar to the one defined below. The following XML DTD was defined based on the order used in the JPIP Cache-Model defined in the JPIP standard. Also alternate element and attribute names can be used. As an example for brevity and storage space reduction the element “tile” may be instead named as element “t”. In alternate embodiments, the start and end attributes will not be defined as “required” in the DTD. In this case if the start and/or end attributes are missing for an element, an implicit value may be assigned to them.

XML DTD:

<!-- XML DTD definition for client side cache modeling for JPIP client
-->
<!ELEMENT icm (head?, tile*)>
<!ELEMENT head (metadata*)>
<!ELEMENT metadata EMPTY>
<!ATTLIST metadata

| | |
|---|---|
| name NMTOKEN | #REQUIRED |
| value CDATA | #REQUIRED |

>
<!ENTITY % jp2elementattributes “

| | |
|---|---|
| start | CDATA #REQUIRED |
| end | CDATA #REQUIRED |
| identifier | CDATA #IMPLIED |

```
”>
<!ELEMENT tile (component) *>
<!ATTLIST tile
    %jp2elementattributes;
>
<!ELEMENT component (resolution) *>
<!ATTLIST component
    %jp2elementattributes;
>
<!ELEMENT resolution (precinct) *>
<!ATTLIST resolution
    %jp2elementattributes;
>
<!ELEMENT precinct (layer) *>
<!ATTLIST precinct
    %jp2elementattributes;
>
<!ELEMENT layer (#PCDATA)>
<!ATTLIST layer
    %jp2elementattributes;
```

XML Schema:

```
<?xml version=“1.0” encoding=“UTF-8”?>
<!-- XML Schema for client side cache modeling for JPIP client
Author: Sachin Deshpande, Sharp Laboratories of America Inc.
-->
<xs:schema xmlns:xs=“http://www.w3.org/2001/XMLSchema”
elementFormDefault=“qualified”>
    <xs:element name=“component”>
        <xs:complexType>
            <xs:sequence minOccurs=“0” maxOccurs=“unbounded”>
                <xs:element ref=“resolution”/>
            </xs:sequence>
            <xs:attribute name=“start” type=“xs:string” use=“required”/>
            <xs:attribute name=“end” type=“xs:string” use=“required”/>
            <xs:attribute name=“identifier” type=“xs:string”/>
        </xs:complexType>
    </xs:element>
    <xs:element name=“icm”>
        <xs:complexType>
            <xs:sequence>
                <xs:element ref=“head” minOccurs=“0”/>
                <xs:element ref=“tile” minOccurs=“0”
maxOccurs=“unbounded”/>
            </xs:sequence>
        </xs:complexType>
    </xs:element>
    <xs:element name=“head”>
        <xs:complexType>
            <xs:sequence>
                <xs:element ref=“metadata” minOccurs=“0”
maxOccurs=“unbounded”/>
            </xs:sequence>
        </xs:complexType>
    </xs:element>
    <xs:element name=“layer”>
        <xs:complexType>
            <xs:simpleContent>
                <xs:extension base=“xs:string”>
                    <xs:attribute name=“start” type=“xs:string”
use=“required”/>
                    <xs:attribute name=“end” type=“xs:string”
use=“required”/>
                    <xs:attribute name=“identifier”
type=“xs:string”/>
                </xs:extension>
            </xs:simpleContent>
        </xs:complexType>
    </xs:element>
    <xs:element name=“metadata”>
        <xs:complexType>
            <xs:attribute name=“name” type=“xs:NMTOKEN” use=“required”/>
            <xs:attribute name=“value” type=“xs:string” use=“required”/>
        </xs:complexType>
    </xs:element>
    <xs:element name=“precinct”>
        <xs:complexType>
            <xs:sequence minOccurs=“0” maxOccurs=“unbounded”>
                <xs:element ref=“layer”/>
            </xs:sequence>
            <xs:attribute name=“start” type=“xs:string” use=“required”/>
            <xs:attribute name=“end” type=“xs:string” use=“required”/>
            <xs:attribute name=“identifier” type=“xs:string”/>
        </xs:complexType>
    </xs:element>
    <xs:element name=“resolution”>
        <xs:complexType>
            <xs:sequence minOccurs=“0” maxOccurs=“unbounded”>
                <xs:element ref=“precinct”/>
            </xs:sequence>
            <xs:attribute name=“start” type=“xs:string” use=“required”/>
            <xs:attribute name=“end” type=“xs:string” use=“required”/>
            <xs:attribute name=“identifier” type=“xs:string”/>
        </xs:complexType>
    </xs:element>
    <xs:element name=“tile”>
        <xs:complexType>
            <xs:sequence minOccurs=“0” maxOccurs=“unbounded”>
                <xs:element ref=“component”/>
            </xs:sequence>
            <xs:attribute name=“start” type=“xs:string” use=“required”/>
            <xs:attribute name=“end” type=“xs:string” use=“required”/>
            <xs:attribute name=“identifier” type=“xs:string”/>
        </xs:complexType>
    </xs:element>
</xs:schema>
```

The XML DTD/Schema can also be used by the JPIP server side 804 to model its view of the client cache 802. In this case the server 804 will build and modify its view of the client side cache model 814a based on the Cache-Model: add=<data-bin descriptors> and Cache-Model: subtract=<data-bin descriptor> headers received from the client 802. When a JPIP request is received from the client 802, the JPIP server 804 can use this client cache model view to decide what data it needs to send based on what is already present in the client cache 814a.

A description of an initial implementation of the exemplary XML Based JPIP Client Side Cache Modeling will now be described. Java DOM API was used for the implementation. Results will be shown from a graphical viewer which shows a tree view of the XML based client side cache model. In this implementation, DOM API is used to add or remove nodes in the tree. The add node operation is typically done after a new cache data arrives from the server 804 and is added to the cache 802. This will also result in a Cache-Model: add=<data-bin descriptors> header to be sent to the JPIP server 804. A remove node operation will be typically done after a cached data entity is purged for any reason from the client side 802. This will also result in a Cache-Model: subtract=<data-bin descriptor> header to be sent to the JPIP server 804.

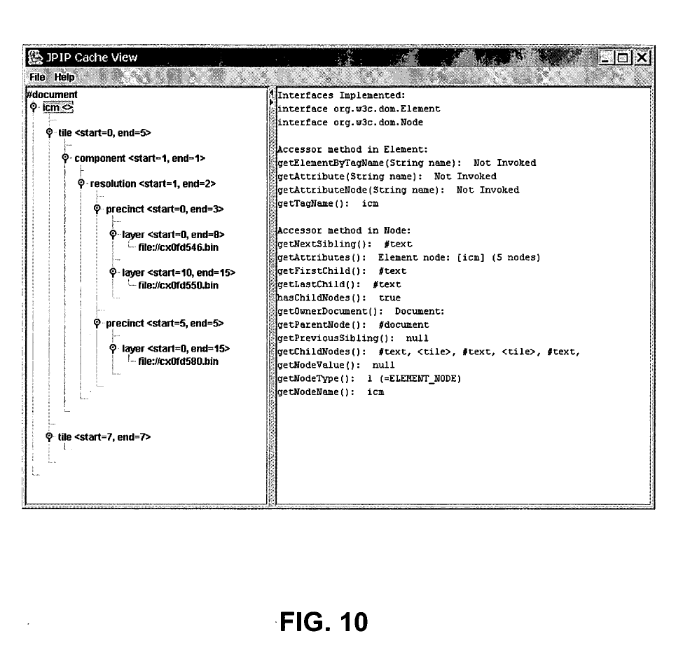

FIG. 10 shows the client side cache model view when the session is started. In this case the previous session resulted in a cache state, which was saved using the exemplary XML DTD/Schema into an XML file. At the start of a new session this XML file can be read and parsed using DOM API to obtain a tree representation of the current cache state.

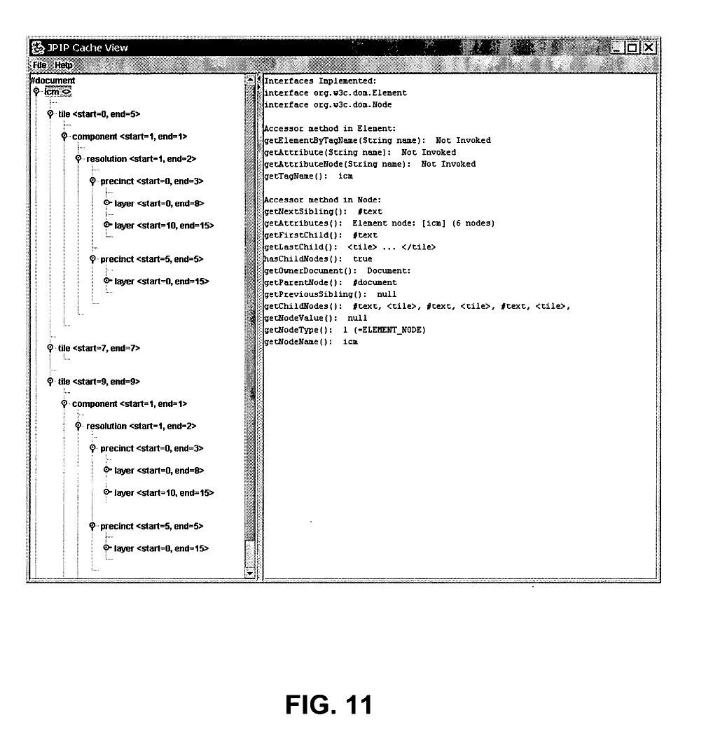

FIG. 11 shows the client side cache model view while the client 802 and JPIP server 804 are in a session. In this particular case a new tile was acquired by the client 802 from the server 804 and was added to the client cache 808. This resulted in the client side XML cache model 814a adding a node, which results in the client side cache model view shown in FIG. 11.

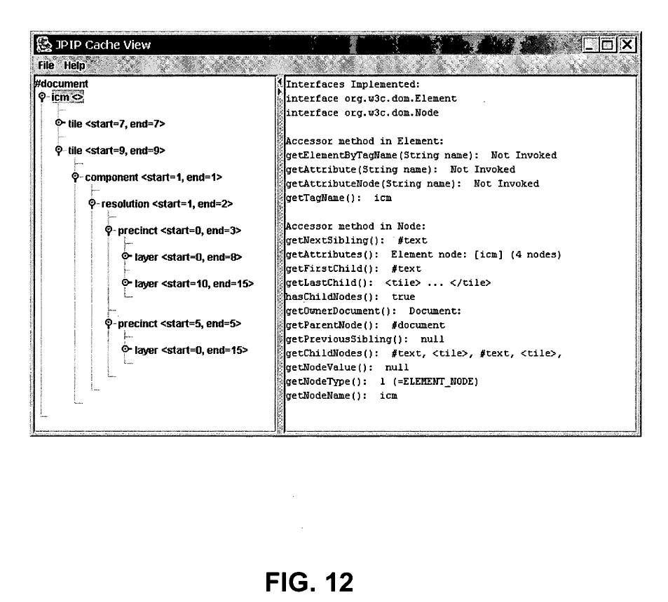

Finally during the session the client 802 purges one of the cached data. This results in the client side cache model 814a removing a node. The client side cache model view in tree form after this operation is shown in FIG. 12. Assuming that the server-client session ends at this point, DOM API is used to store the last cache state into a XML file which can be used to initialize the next server client session for this JPEG2000 image 806.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

1. A cache manager for implementing a method in a client, wherein the client comprises a cache, wherein the cache comprises a portion of an image file received from a server, and wherein the method comprises:
creating a cache model, wherein the cache model comprises a representation of contents of the cache;
saving the cache model on the client; and
updating the cache model to reflect modifications made to the contents of the cache.

2. The cache manager of claim 1, wherein creating the cache model comprises loading a previously saved cache model.

3. The cache manager of claim 1, wherein the image file comprises compressed image data, and wherein the compressed image data is configured to be decompressed in different ways to display different images with different properties.

4. The cache manager of claim 3, wherein the image file is formatted in accordance with JPEG2000.

5. The cache manager of claim 1, wherein the cache model comprises:
an identifier of the portion of the image file; and
at least one characteristic of an image that is displayed from the portion of the image file.

6. The cache manager of claim 5, wherein the cache model further comprises:
a tile data structure;
a component data structure;
a resolution data structure;
a precinct data structure; and
a layer data structure.

7. The cache manager of claim 6, wherein the tile data structure, the component data structure, the resolution data structure, the precinct data structure, and the layer data structure are related to each other in accordance with a hierarchy that corresponds to a progression order of the image file.

8. The cache manager of claim 7, wherein the identifier is embedded within the lowest data structure in the hierarchy.

9. The cache manager of claim 6, wherein the at least one characteristic comprises:
a tile that is specified in a tile attribute of the tile data structure;
a component that is specified in a component attribute of the component data structure;
a resolution that is specified in a resolution attribute of the resolution data structure;
a precinct that is specified in a precinct attribute of the precinct data structure; and
a layer that is specified in a layer attribute of the layer data structure.

10. The cache manager of claim 1, wherein the cache model comprises an XML file.

11. The cache manager of claim 1, wherein the cache model comprises XML data.

12. The cache manager of claim 1, wherein the method further comprises modifying the cache.

13. The cache manager of claim 1, wherein the method further comprises sending update information to the server, wherein the update information describes the modifications made to the contents of the cache.

14. The cache manager of claim 1, wherein the updating of the cache model is accomplished via a document object model.

15. The cache manager of claim 1, wherein the updating of the cache model is accomplished via an XML document object model application programming interface.

16. The cache manager of claim 2, wherein the method further comprises associating saved cache model information with the image file and with the server.

17. The cache manager of claim 16, wherein the method further comprises reading the saved cache model information based on the image file and the server.

18. A cache manager for implementing a method in a server, wherein the server models contents of a cache on a client, wherein the cache comprises a portion of an image file received from the server, and wherein the method comprises:
creating a cache model, wherein the cache model comprises a representation of the contents of the cache on the client;
saving the cache model on the server; and
updating the cache model to reflect modifications made to the contents of the cache on the client based on information sent by the client to the server.

19. The cache manager of claim 18, wherein creating the cache model comprises loading a previously saved cache model.

20. The cache manager of claim 18, wherein the image file comprises compressed image data, and wherein the compressed image data is configured to be decompressed in different ways to display different images with different properties.

21. The cache manager of claim 20, wherein the image file is formatted in accordance with JPEG2000.

22. The cache manager of claim 18, wherein the cache model comprises:
an identifier of the portion of the image file; and
at least one characteristic of an image that is displayed from the portion of the image file.

23. The cache manager of claim 22, wherein the cache model further comprises:
a tile data structure;
a component data structure;
a resolution data structure;
a precinct data structure; and
a layer data structure.

24. The cache manager of claim 23, wherein the tile data structure, the component data structure, the resolution data structure, the precinct data structure, and the layer data structure are related to each other in accordance with a hierarchy that corresponds to a progression order of the image file.

25. The cache manager of claim 24, wherein the identifier is embedded within the lowest data structure in the hierarchy.

26. The cache manager of claim 23, wherein the at least one characteristic comprises:
a tile that is specified in a tile attribute of the tile data structure;
a component that is specified in a component attribute of the component data structure;
a resolution that is specified in a resolution attribute of the resolution data structure;
a precinct that is specified in a precinct attribute of the precinct data structure; and
a layer that is specified in a layer attribute of the layer data structure.

27. The cache manager of claim 18, wherein the cache model comprises an XML file.

28. The cache manager of claim 18, wherein the cache model comprises XML data.

29. The cache manager of claim 18, wherein the updating of the cache model is accomplished via a document object model.

30. The cache manager of claim 18, wherein the updating of the cache model is accomplished via an XML document object model application programming interface.

31. The cache manager of claim 18, wherein the method further comprises associating saved cache model information with the image file and with the client.

32. The cache manager of claim 31, wherein the method further comprises reading the saved cache model information based on the image file and the client.

33. A client that is in electronic communication with a server, comprising:
a cache that stores a portion of a compressed image file received from the server, wherein the compressed image file is configured to be decompressed in different ways to display different images with different properties;
a cache model that comprises a representation of contents of the cache; and
a cache manager that updates the cache model to reflect modifications made to the contents of the cache.

34. The client of claim 33, wherein the compressed image file is formatted in accordance with JPEG2000.

35. The client of claim 33, wherein the cache model comprises:
an identifier of the portion of the compressed image file; and
at least one characteristic of an image that is displayed from the portion of the compressed image file.

36. The client of claim 33, wherein the cache model comprises an XML file.

37. The client of claim 33, wherein the cache model comprises XML data.

38. The client of claim 33, wherein the cache manager updates the cache model via a document object model.

39. The client of claim 33, wherein the cache manager updates the cache model via an XML document object model application programming interface.

40. A server that is in electronic communication with a client, comprising:
a cache model that comprises a representation of contents of a cache on the client, wherein the cache stores a portion of a compressed image file received from the server, and wherein the compressed image file is configured to be decompressed in different ways to display different images with different properties; and
a cache manager that updates the cache model to reflect modifications made to the contents of the cache based on information sent by the client to the server.

41. The server of claim 40, wherein the compressed image file is formatted in accordance with JPEG2000.

42. The server of claim 40, wherein the cache model comprises:
an identifier of the portion of the compressed image file; and
at least one characteristic of an image that is displayed from the portion of the compressed image file.

43. The server of claim 40, wherein the cache model comprises an XML file.

44. The server of claim 40, wherein the cache model comprises XML data.

45. The server of claim 40, wherein the cache manager updates the cache model via a document object model.

46. The server of claim 40, wherein the cache manager updates the cache model via an XML document object model application programming interface.

47. In a client that comprises a cache that stores a portion of a compressed image file received from a server, a method comprising:
creating a cache model, wherein the cache model comprises a representation of contents of the cache;
saving the cache model on the client; and
updating the cache model to reflect modifications made to the contents of the cache.

48. The method of claim 47, wherein creating the cache model comprises loading a previously saved cache model.

49. The method of claim 47, wherein the image file comprises compressed image data, and wherein the compressed image data is configured to be decompressed in different ways to display different images with different properties.

50. The method of claim 47, wherein the updating of the cache model is accomplished via a document object model.

51. The method of claim 47, wherein the updating of the cache model is accomplished via an XML document object model application programming interface.

52. The method of claim 47, further comprising associating saved cache model information with the image file and with the server.

53. The method of claim 52, further comprising reading the saved cache model information based on the image file and the server.

54. The method of claim 47, further comprising sending update information to the server, wherein the update information describes the modifications made to the contents of the cache.

55. In a server, a method comprising:
creating a cache model, wherein the cache model comprises a representation of contents of a cache on a client;
saving the cache model on the server; and
updating the cache model to reflect modifications made to the contents of the cache based on information sent by the client to the server.

56. The method of claim 55, wherein creating the cache model comprises loading a previously saved cache model.

57. The method of claim 55, wherein the updating of the cache model is accomplished via a document object model.

58. The method of claim 55, wherein the updating of the cache model is accomplished via an XML document object model application programming interface.

59. The method of claim 55, further comprising associating saved cache model information with the image file and with the client.

60. The method of claim 59, further comprising reading the saved cache model information based on the image file and the client.

61. A cache manager for implementing a method in a client that is configured for communication with a server in accordance with JPEG2000 Interactive Protocol (JPIP), wherein the client comprises a cache, wherein the cache comprises a portion of a JPEG2000 image file received from the server, and wherein the method comprises:
saving cache information about contents of the cache into an XML file in accordance with an XML DTD/schema;
reading the XML file;
using XML Document Object Model (DOM) Application Programming Interface (API) to create a hierarchical representation of the cache information;
when first data is added to the cache, using the XML DOM API to add a first node to the hierarchical representation; and
when second data is removed from the cache, using the XML DOM API to delete a second node from the hierarchical representation.

62. The cache manager of claim 61, wherein the method further comprises sending a Cache-Model: add=<data-bin descriptors> header to the server when the first data is added to the cache.

63. The cache manager of claim 61, wherein the method further comprises sending a Cache-Model: subtract=<data-bin descriptors> header to the server when the second data is removed from the cache.

64. The cache manager of claim 61, wherein the XML DTD/schema defines a tile element, a component element, a resolution element, a precinct element, and a layer element.

65. The cache manager of claim 64, wherein the tile element, the component element, the resolution element, the precinct element, and the layer element each have required attributes of start and end.

66. The cache manager of claim 64, wherein the tile element, the component element, the resolution element, the precinct element, and the layer element each have an implied attribute of identifier.

67. The cache manager of claim 64, wherein the XML DTD/schema defines a progression order for the tile element, the component element, the resolution element, the precinct element, and the layer element.
